(19) United States
(12) Patent Application Publication
(10) Pub. No.: US 2006/0177667 A1
(43) Pub. Date: Aug. 10, 2006

(54) Bonding laminate unit and laminated composite including the same

(76) Inventor: Chun-Wei Lin, Taichung Hsien (TW)

Correspondence Address: FROMMER LAWRENCE & HAUG, 745 FIFTH AVENUE- 10TH FL., NEW YORK, NY, 10151, US

(21) Appl. No.: 11/053,621

(22) Filed: Feb. 8, 2005

(51) Int. Cl. B32B 9/04; B32B 7/04; B32B 27/40

(52) U.S. Cl. 428/411.1; 428/420; 428/423.1; 428/424.8

(57) ABSTRACT

A bonding laminate unit includes a skin layer made from a skin composition containing a polyurethane resin and having an outer face and an inner face opposite to the outer face, a binder layer formed on the inner face of the skin layer and made from a binder composition, the binder composition containing a styrene-butadiene-styrene block copolymer grafted with a monomer, and a base layer formed on the binder layer and made from a base composition, the base composition containing a styrene-butadiene-styrene block copolymer.

### BACKGROUND OF THE INVENTION

1. Field of the Invention

This invention relates to a bonding laminate unit, more particularly to a bonding laminate unit including a base layer made from a base composition containing a styrene-butadiene-styrene (SBS) block copolymer, a binder layer made from a binder composition containing a SBS block copolymer grafted with a monomer, and a skin layer made from a skin composition containing a polyurethane (PU) resin.

2. Description of the Related Art

Due to increased awareness of animal protection, regulations governing the acquisition and use of animal leathers have become more stringent. Hence, market demands for artificial leathers have increased. Conventional artificial leathers are generally formed by attaching one or more polymer layers to a base fabric layer. The artificial leathers thus formed can be used to manufacture shoes, furniture, car interior products, suitcases, bags, garments, and the like.

Polyvinyl chloride (PVC) is one of the raw materials conventionally used to manufacture the polymer layers of artificial leathers. Polymer layers made from PVC are waterproof and can improve the structure of the base fabric layer, while affording a good hand feel and a good flexion feel. However, it is recently found that use of PVC produces pollutants, such as dioxin, heavy metals and phthalates, which are harmful to the environment. Therefore, the use of PVC is gradually prohibited and there is a pressing need in the art to look for environmental-friendly materials.

Wet PU is another conventionally used raw material. Due to higher production cost of wet PU as compared with PVC, a mixture of styrenic block polymers and PU has been proposed to replace wet PU. However, the compatibility of the styrenic block polymers with PU is poor so that the styrenic block polymers and PU cannot be bonded together satisfactorily, thereby resulting in surface-peeling or detachment.

In order to improve the compatibility of styrenic block polymers and PU, there has been proposed a composite fabric which includes a fabric layer and a backing laminate having a tri-ply structure. The backing laminate includes a binder layer applied to the fabric layer, an intermediate layer applied to the binder layer, and a surface-modifying layer applied to the intermediate layer. The binder layer has a binder composition containing a SBS block copolymer grafted with an acrylate monomer, and PU blended with the SBS block copolymer which has been grafted. The intermediate layer has a composition containing a SBS block copolymer and a solvent. Although the aforesaid backing laminate is capable of imparting good hand feel to the composite fabric, there is still a need in the art for a laminate material that can be produced at a low cost and that does not have the problem of surface-peeling.

### SUMMARY OF THE INVENTION

Therefore, the object of the present invention is to provide a bonding laminate unit that eliminates the drawbacks of the afore said prior art.

According to one aspect of this invention, there is provided a bonding laminate unit including: a skin layer made from a skin composition containing a polyurethane resin and having an outer face and an inner face opposite to the outer face; a binder layer formed on the inner face of the skin layer and made from a binder composition, the binder composition containing a styrene-butadiene-styrene block copolymer grafted with a monomer; and a base layer formed on the binder layer and made from a base composition, the base composition containing a styrene-butadiene-styrene block copolymer.

According to another aspect of this invention, there is provided a laminated composite adapted to be attached to an article, including: a bonding laminate unit including a skin layer made from a skin composition containing a polyurethane resin and having an outer face and an inner face opposite to the outer surface, a binder layer formed on the inner face of the skin layer and made from a binder composition, the binder composition containing a styrene-butadiene-styrene block copolymer grafted with a monomer, and a base layer formed on the binder layer and made from a base composition, the base composition containing a styrene-butadiene-styrene block copolymer; a fabric-binding layer formed on the base layer of the binding laminate unit; and a fabric layer attached to the base layer through the fabric-binding layer.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view to illustrate the preferred embodiment of a bonding laminate unit according to the present invention;

FIG. 2 is a schematic view to illustrate the preferred embodiment of a laminated composite according to the present invention;

FIG. 3 is a schematic view to illustrate an apparatus usable in fabricating the laminated composite of the present invention;

FIG. 4 is a schematic view to illustrate another apparatus usable in fabricating the laminated composite of the present invention;

FIG. 5 is a schematic view to illustrate still another apparatus usable in fabricating the laminated composite of the present invention;

FIG. 6 is a schematic view to illustrate yet another apparatus usable in fabricating the laminated composite of the present invention; and

FIG. 7 is a schematic view to illustrate a further apparatus usable in fabricating the laminated composite of the present invention.

### DETAILED DESCRIPTION OF THE PREFERRED EMBODIMENT

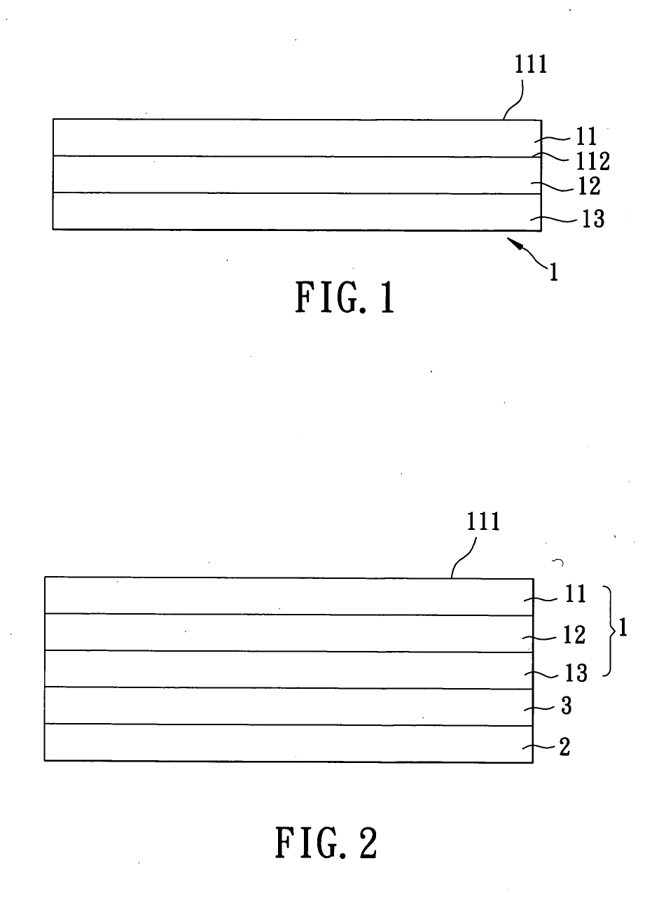

Referring to FIG. 1, the preferred embodiment of a bonding laminate unit 1 according to this invention includes a skin layer 11 having an outer face 111 and an inner face 112 opposite to the outer face 111, a binder layer 12 formed on the inner face 112 of the skin layer 11, and a base layer 13 formed on the binder layer 12.

The skin layer 11 is made from a skin composition containing a polyurethane resin. When the bonding laminate unit 1 of this invention is attached to another material, such as a fabric or wooden material, to form a product, the outer face 111 of the skin layer 11 serves as the outside of the product and can be embossed to form a desired pattern.

Furthermore, during formation of the skin layer 11, an additive can be added to the skin composition in a conventional manner so as to achieve a desired property. For example, a smoothing agent can be added to enhance surface smoothness and to provide an anti-scratch property to the outer surface 111 of the skin layer 11. Alternatively, a matting agent can be added to provide the outer surface 111 of the skin layer 11 with a frosted effect. It should be noted that the skin layer 11 will become tacky if the smoothing agent is excessive, and that the skin layer 11 will have a poor anti-scratch property if the matting agent is excessive.

The binder composition contains a styrene-butadiene-styrene block copolymer grafted with a monomer. Preferably, the monomer grafted with the SBS block copolymer is selected from the group consisting of acrylic acid, acrylates, methacrylic acid, methacrylates, hydroxy ethyl methacrylate, maleic anhydride, and a combination thereof.

Acrylates suitable for grafting to the styrene-butadiene-styrene block copolymer include, but are not limited to, methyl acrylate (MA), ethyl acrylate (EA), butyl acrylate (BA), and 2-ethylhexyl acrylate (2-HEA) . Methacrylates suitable for grafting to the styrene-butadiene-styrene block copolymer include, but are not limited to, ethyl methacrylate (EMA), glycidyl methacrylate (GMA), isobutyl methacrylate (IBMA), lauryl methacrylate (LMA), n-butyl methacrylate (NBMA), stearyl methacrylate (SMA), 2-ethylhexyl methacrylate (2-EHMA), 2-hydroxypropyl methacrylate (2-HPMA), and dimethylaminoethyl methacrylate (DMAEMA).

Preferably, the monomer grafted to the styrene-butadiene-styrene block copolymer is selected from the group consisting of acrylic acid, methacrylic acid, hydroxy ethyl methacrylate, maleic anhydride, and a combination thereof. More preferably, the monomer grafted to the styrene-butadiene-styrene block copolymer is acrylic acid.

The ratio of the styrene-butadiene-styrene block copolymer to the monomer can be adjusted according to the desired specification of the bonding laminate unit 1. A catalyst or a solvent may be optionally added to the binder composition during the graft polymerization of the styrene-butadiene-styrene block copolymer and the monomer. Catalysts suitable for the graft polymerization reaction include benzoyl peroxide (BPO). Solvents suitable for the graft polymerization include toluene, n-butyl acetate and cyclohexane. Preferably, the solvent used for the graft polymerization is toluene. The viscosity of the binder composition can be adjusted by adding a solvent so as to maintain the viscosity of the binder composition in a preferred range of 500 to 30,000 cps.

The base layer 13 is made from a base composition containing a styrene-butadiene-styrene block copolymer, and has a first surface attached to the binder layer 12 and a second surface that is opposite to the first surface and that is adapted to be bonded to other material layers. In addition to the SBS block copolymer, the base composition further contains a plasticizer. Preferably, the plasticizer is selected form the group consisting of paraffinic oil and napthehenic oil. The hardness and tensile strength of the bonding laminate unit depend on the amount of the plasticizer added to the base composition. Therefore, the amount of the plasticizer added to the base composition can be adjusted and modified based on the specification of the SBS block copolymer and the required quality of the bonding laminate unit 1. It should be noted that migration may occur if the amount of the plasticizer used is excessive.

The specification of the SBS block copolymer in the base composition may be chosen or changed according to the manufacturing process and the required physical properties of the bonding laminate unit 1. It should be noted that the tensile strength of the bonding laminate unit 1 is related to the tearing strength and the seam strength thereof, and that the flexion feel of the bonding laminate unit 1 is determined by the hardness and rebound elasticity thereof. The tensile strength of the bonding laminate unit 1 changes with the molecular weight of the SBS block copolymer. The hardness of the bonding laminate unit 1 is determined by the ratio of styrene to butadiene and by the amount of plasticizer in the base composition. The rebound elasticity of the bonding laminate unit 1 is determined by the ratio of styrene to butadiene in the base composition.

In order to reduce the weight of the base layer 13 and to improve the flexion feel of the bonding laminate unit 1, the base composition may optionally contain a blowing agent. The blowing agent may be any commercial available blowing agent known to one skilled in the art. In addition, a filling agent conducive to the formation of bubbles, such as calcium carbonate or talcum powder, may be added to the base composition in a conventional manner and in accordance with the quality requirements.

Referring to FIG. 2, a laminated composite of this invention which is adapted to be attached to an article includes a bonding laminate unit 1 as illustrated in FIG. 1, a fabric-binding layer 3 formed on the base layer 13 of the binding laminate unit 1, and a fabric layer 2 attached to the base layer 13 through the fabric-binding layer 3.

### EXAMPLES

### Examples of the Base, Binder, and Skin Compositions used to Form the Bonding Laminate Unit of the Present Invention

I. Skin Composition for the Skin Layer 11

The skin composition for the skin layer 11 was made from a paste prepared by mixing 100 parts by weight of polyurethane, 0 to 5 parts by weight of a pigment, 0.1 to 1 part by weight of a smoothing agent, and 1 to 5 parts by weight of a matting agent.

II. Binder Composition for the Binder Layer 12 and the Fabric-Binding Layer 3

The binder composition for the binder layer 12 and the fabric-binding layer 3 was prepared by mixing 15 parts by weight of SBS block copolymer with 15 parts by weight of acrylic acid. A graft polymerization was carried out in the presence of 69.6 parts by weight of toluene, 0.2 parts by weight of benzoyl peroxide, and 0.2 parts by weight of an antioxidant, at a temperature of about 85° C. for 4 to 5 hours.

III. Base Composition for the Base Layer 13

The base composition for the base layer 13 was prepared by mixing 100 parts by weight of SBS block copolymer with 35 parts by weight of a plasticizer (paraffinic oil or napthehenic oil), 2.4 parts by weight of a blowing agent, 3 to 12 parts by weight of a filling agent, 1 to 3 parts by weight of a pigment, and 0.4 parts by weight of an antioxidant. The resultant mixture subsequently underwent a reaction at a temperature of 125° C. to 135° C.

Fabrication of the Bonding Laminate Unit and the Laminated Composite of the Present Invention

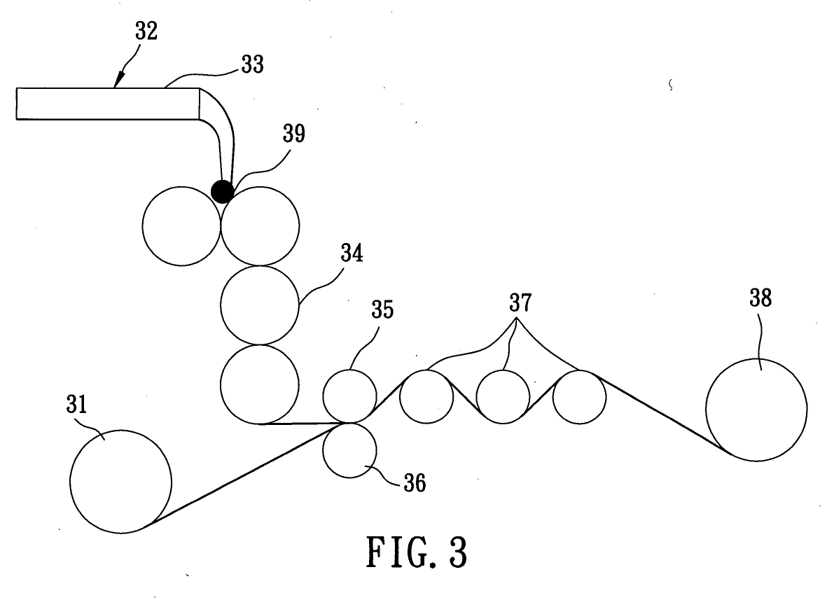

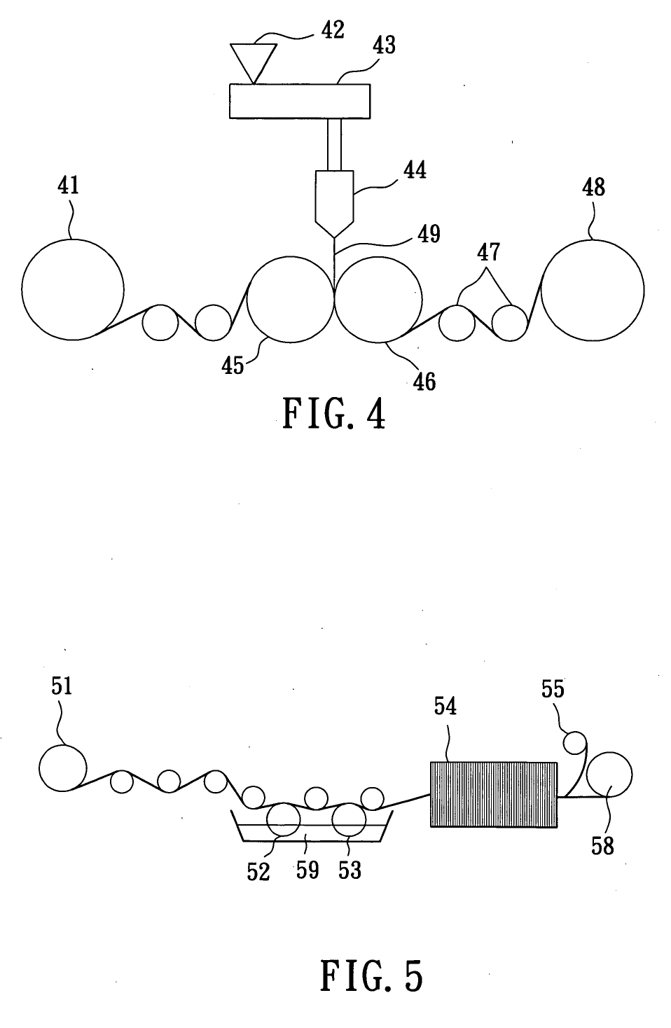

The base composition thus prepared was coated onto a polyethylene film by a calendering process or a film coating process so as to form a base layer 13 on the polyethylene film. FIG. 3 illustrates an apparatus used in the calendering process, whereas FIG. 4 illustrates an apparatus used in the film coating process. The polyethylene film is used for preventing the base layer 13 from curling and sticking to itself.

Referring to FIG. 3, the apparatus used in the calendering process includes a take-up roller 31 for winding a base material, such as the polyethylene film, a feed hopper 32, an extruder 33, a reverse L calendering rollers 34, an embossing roller 35, a rubber roller 36, a cooling roller unit 37, and a semi-product take-up roller 38. Reference numeral 39 denotes a coating material, such as the base composition.

Referring to FIG. 4, the apparatus used in the film coating process includes a take-up roller 41 for winding a base material, such as the polyethylene film, a feed hopper 42, an extruder 43, a T-die 44, a rubber roller 45, an embossing roller 46, a cooling roller unit 47, and a semi-product take-up roller 48. Reference numeral 49 denotes a coating material, such as the base composition.

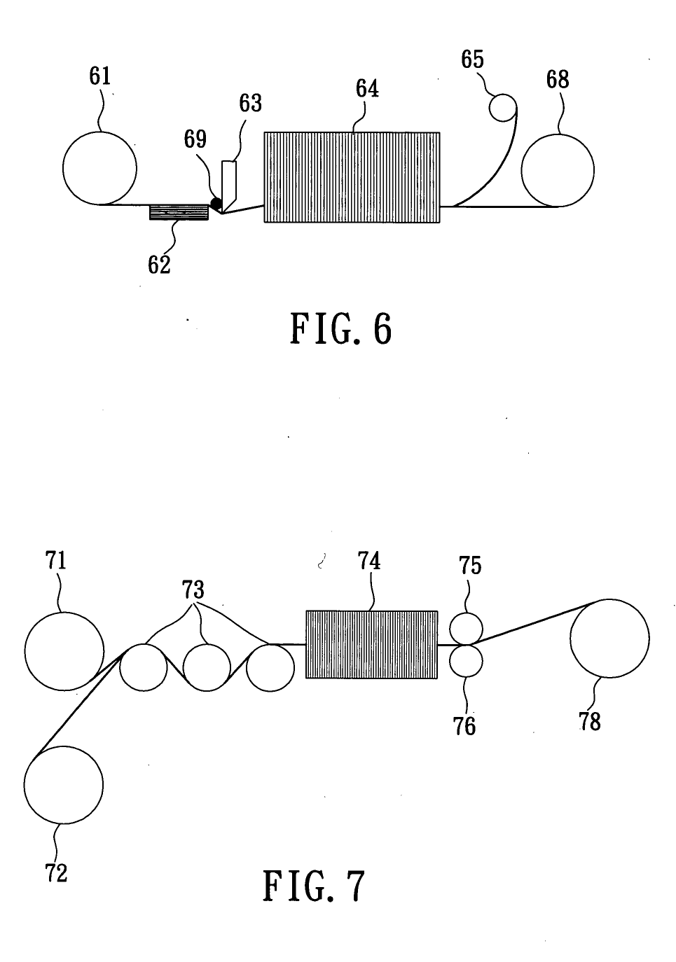

After the base layer 13 is formed on the polyethylene film, the binder composition is applied to the base layer 13 by a knife coating process or a gap coating process, and the polyethylene film is simultaneously removed from the base layer 13 so as to form a binder layer 12 on the base layer 13. Subsequently, similar to the formation of the binder layer 12 on the base layer 13, the skin composition is applied to the binder layer 12 by a knife coating process or a gap coating process so as to form a skin layer 11 on the binder layer 12, thereby resulting in a bonding laminate unit 1 of the present invention. FIG. 5 illustrates an apparatus used in the gap coating process, whereas FIG. 6 illustrates an apparatus used in the knife coating process.

Referring to FIG. 5, the apparatus used in the gap coating process includes a take-up roller 51 for winding a base material, such as the polyethylene film coated with the base layer 13, a forward roller 52, a reverse roller 53, an oven 54, a polyethylene film take-up roller 55, and a semi-product take-up roller 58. Reference numeral 59 denotes a coating material, such as the binder composition or the skin composition.

Referring to FIG. 6, the apparatus used in the knife coating process includes a take-up roller 61 for winding a base material, such as the polyethylene film coated with the base layer 13, a supporting plate 62, a knife 63, an oven 64, a polyethylene film take-up roller 65, and a semi-product take-up roller 68. Reference numeral 69 denotes a coating material, such as the binder composition or the skin composition.

In fabricating the laminated composite of the present invention, the binder composition is applied to a fabric layer 2 by a knife coating process so as to form a binder fabric including the fabric layer 2 formed with a fabric-binding layer 3. The fabric-binding layer 3 of the binder fabric and the base layer 13 of the bonding laminate unit 1 are laminated together by a laminating process so as to form the laminated composite of this invention. FIG. 7 illustrates an apparatus used in the laminating process. The apparatus includes a first take-up roller 71, a second take-up roller 72, a pre-heat roller unit 73, an oven 74, a soft rubber roller 75, an embossing roller 76 and a product take-up roller 78.

During the laminating process, the bonding laminate unit 1 is wound around the first take-up roller 71 and the binder fabric is wound around the second take-up roller 72. The base layer 13 of the bonding laminate unit 1 and the fabric-binding layer 3 of the binder fabric are laminated together face-to-face by passing through the pre-heat roller unit 73, the oven 74, the soft rubber roller 75, and the embossing roller 76. The laminated composite thus formed is subsequent wound around the product take-up roller 78.

It should be noted that the fabrication of the bonding laminate unit 1 and the laminated composite of the present invention is not limited to the afore said processes. Other conventional methods known to the skilled artisans can also be utilized. For example, the skin layer 11 of the bonding laminate unit 1 of the laminated composite can be firstly applied to an embossed release paper and the binder layer 12 and the base layer 13 are applied to the skin layer 11 in sequence. The base layer 13 is subsequently laminated with the fabric layer 2 formed with the fabric-binding layer 3 so as to obtain a bonding laminate unit 1 with an embossed skin layer 11.

In view of the foregoing, the bonding laminate unit 1 and the laminated composite of this invention can be produced at a low cost and are not susceptible to surface-peeling.

While the present invention has been described in connection with what is considered the most practical and preferred embodiment, it is understood that this invention is not limited to the disclosed embodiment but is intended to cover various arrangements within the spirit and scope of the broadest interpretations and equivalent arrangements.

What is claimed is:

1. A bonding laminate unit, comprising:
a skin layer made from a skin composition containing a polyurethane resin and having an outer face and an inner face opposite to said outer face;
a binder layer formed on said inner face of said skin layer and made from a binder composition, said binder composition containing a styrene-butadiene-styrene block copolymer grafted with a monomer; and
a base layer formed on said binder layer and made from a base composition, said base composition containing a styrene-butadiene-styrene block copolymer.

2. The bonding laminate unit as claimed in claim 1, wherein said monomer grafted to said styrene-butadiene-styrene block copolymer is selected from the group consisting of acrylic acid, acrylates, methacrylic acid, methacrylates, hydroxy ethyl methacrylate, maleic anhydride, and a combination thereof.

3. The bonding laminate unit as claimed in claim 2, wherein said monomer is acrylic acid.

4. The bonding laminate unit as claimed in claim 3, wherein said base composition further contains a plasticizer.

5. The bonding laminate unit as claimed in claim 4, wherein said plasticizer is selected form the group consisting of paraffinic oil and napthehenic oil.

6. The bonding laminate unit as claimed in claim 5, wherein said base composition further includes a blowing agent.

7. A laminated composite adapted to be attached to an article, comprising:
a bonding laminate unit including
a skin layer made from a skin composition containing a polyurethane resin and having an outer face and an inner face opposite to said outer surface,
a binder layer formed on said inner face of said skin layer and made from a binder composition, said binder composition containing a styrene-butadiene-styrene block copolymer grafted with a monomer, and
a base layer formed on said binder layer and made from a base composition, said base composition containing a styrene-butadiene-styrene block copolymer;
a fabric-binding layer formed on said base layer of said binding laminate unit; and
a fabric layer attached to said base layer through said fabric-binding layer.

8. The laminated composite as claimed in claim 7, wherein said monomer grafted to said styrene-butadiene-styrene block copolymer is selected from the group consisting of acrylic acid, acrylates, methacrylic acid, methacrylates, hydroxy ethyl methacrylate, maleic anhydride, and a combination thereof.

9. The laminated composite as claimed in claim 8, wherein said monomer is acrylic acid.

10. The laminated composite as claimed in claim 9, wherein said base composition further includes a plasticizer.

11. The laminated composite as claimed in claim 10, wherein said plasticizer is selected form the group consisting of paraffinic oil and napthehenic oil.

12. The laminated composite as claimed in claim 11, wherein said base composition further includes a blowing agent.
